(19) United States
(12) Patent Application Publication
(10) Pub. No.: US 2016/0069195 A1
(43) Pub. Date: Mar. 10, 2016

(54) ROTARY BLADE TIP

(71) Applicant: ROLLS-ROYCE PLC, London (GB)

(72) Inventors: Andrew HEWITT, Derby (GB); Matthew HANCOCK, Derby (GB); Lloyd PALLETT, Derby (GB)

(21) Appl. No.: 14/818,700

(22) Filed: Aug. 5, 2015

(30) Foreign Application Priority Data
Sep. 4, 2014 (GB) 1415626.9

(51) Int. Cl. F01D 5/28

(52) U.S. Cl. CPC F01D 5/288; F05D 2220/32; F05D 2240/307; F05D 2240/31; F05D 2260/95; F05D 2300/6032; F05D 2300/6033; F05D 2300/611; F05D 2300/2261; F05D 2300/2283; F05D 2300/173; F05D 2300/177; F05D 2300/132

(57) ABSTRACT

The present invention provides a blade tip for a rotary blade, the blade tip comprising a first portion and a radially-recessed second portion. A radially outermost surface of the first portion comprises a first abrasive coating e.g. a composite material comprising cubic boron nitride embedded in a matrix of nickel alloy. A radially outermost surface of the second portion comprises a second abrasive coating which has a greater resistance to oxidation than the first abrasive coating. The increased oxidation resistance of the second abrasive coating is achieved by providing a radially outer protective layer and/or using a material having a greater inherent oxidation resistance.

### FIELD OF THE INVENTION

The present invention relates to a turbine blade tip for incorporation into a rotary blade, for example, a rotary turbine blade in a gas turbine engine.

### BACKGROUND OF THE INVENTION

It is desirable to reduce the clearance between the tip of a rotary turbine blade and the turbine casing of a gas turbine engine in order to prevent air flow from by-passing the rotary blade which reduces engine efficiency. However, minimising the clearance between the turbine blade tip and the turbine casing can lead to undesirable rubbing of the turbine blade tips on the turbine casing, which, in turn, can lead to mechanical and thermal damage to the blade due to friction and shear stresses.

It is known to provide a track liner on the interior surface of the turbine casing to provide a shroud for the turbine blade tips. The track liner is formed of an abradable material (e.g. a felt metal-filled honeycomb or ceramic coating) which is abraded by the blade tips to form channels in the track liner into which the turbine blade tips extend.

Known rotary blades tips (which may be integral with the blade body or may be a cap fitted to the blade body) may be solid or may be formed as a “squealer” tip i.e. with a radially-extending rail around the perimeter of the tip defining an internal pocket. A squealer tip having a stepped rail that has a greater radial extension adjacent the forward/upstream (suction) face of the blade is described in U.S. Pat. No. 8,113,779B. This stepped rail is provided to improve the flow of cooling air provided to the squealer tip.

Some blade tips are provided with an abrasive coating such as a composite coating of cubic boron nitride (cBN) particles trapped in a Nickel alloy matrix to facilitate cutting of channel into the track liner during the early running stages of the engine whilst protecting the blade from damage, such as cracking, and overheating. Over time, this coating is depleted through rubbing against the turbine casing and may degrade through oxidation both of which increase the clearance between the blade tip and the turbine casing thus reducing engine efficiency. Furthermore, once the coating has been depleted or degraded, rubbing of the blade tip against the turbine casing e.g. in extreme events such as strong gusts or bird strike, can result in significant mechanical and/or thermal damage to the blade resulting in a reduction in service life.

It is known from GB2075129A and U.S. Pat. No. 4,390,320B to provide a squealer blade tip having a number of radially extending ribs (along the edge of the pressure face, the edge of the suction face and the camber line), each rib having an abrasive alumina coating. The ribs are stepped in height with the radially tallest rib positioned along the edge of the pressure face. When used, the abrasive coating on the radially tallest rib is depleted by rubbing against the shroud and when the radial extension of the tallest rib is sufficiently reduced, the abrasive coating on the second radially tallest rib can abrade the shroud. One problem with this known tip is that the abrasive coating on the second radially tallest rib may have already degraded/oxidised even before the second radially tallest rib makes any contact with the turbine casing. Thus, upon contact of the second radially tallest rib with the turbine casing, no protection is afforded by the coating. Furthermore, since the radially tallest rib is provided on the downstream, pressure face, it offers no protection to the upstream ribs.

Accordingly, there is a need for a blade tip which can effectively abrade the liner on the turbine casing whilst protecting the blade body for a greater period of time than the known blade tips.

### SUMMARY OF THE INVENTION

In a first aspect, the present invention provides a turbine blade tip for a rotary blade, the blade tip comprising a first portion and a radially-recessed second portion, wherein a radially outermost surface of the first portion comprises a first abrasive coating and a radially outermost surface of the second portion comprises a second abrasive coating, the second abrasive coating having a greater resistance to oxidation than the first abrasive coating.

The first portion having a greater radial extension will abrade the liner on the turbine casing during the early running of the engine. During this early running of the engine, the second abrasive coating on the second portion will remain un-abraded (because it is radially recessed) and un-oxidised (owing to its greater resistance to oxidation) and thus will remain available to abrade the turbine casing liner once the first portion has been eroded.

Optional features of the invention will now be set out. These are applicable singly or in any combination with any aspect of the invention.

A rotary blade typically comprises an aerofoil-shaped blade body having a concave (downstream) pressure face and a convex (upstream) suction face. The blade tip will have a corresponding concave (downstream) pressure face and a convex (upstream) suction face.

The blade tip may be integral with the blade body and provided at a radially outer end of the blade body, radially spaced from a blade root.

The blade tip may be provided as a distinct structural cap for subsequent attachment to a blade body. In this case, the blade tip cap will comprise a mounting surface for mounting on the radially outer end of the blade body.

References to the radial dimension (e.g. “radially recessed”, “radial extension”) are intended to refer to a dimension extending from either the root portion of the blade body or the mounting surface of the blade tip cap to the radially outermost surface of the first/second portion.

In some embodiments, the first portion is provided proximal the suction face. In this way, the first (upstream) portion can protect the second (downstream) portion prior to erosion of the first portion.

In some embodiments, the first portion is a first radially extending rail e.g. extending adjacent the suction face and the second portion is a second radially extending rail e.g. extending adjacent the pressure face, the radial extension of the first radially extending rail being greater than the radial extension of the second radially extending rail. The first and second radially extending rails extend from a tip floor which is recessed from both of the radially extending rails and spaces them from one another.

In some embodiments, there are a plurality of alternating first and second portions extending around the periphery of the blade tip. This provides a castellated, radially extending rail extending adjacent the pressure and suction faces of the blade tip.

In some embodiments, the first portion has a radial extension that is between 100 and 400 microns greater than that of the second portion.

In some embodiments, the first abrasive coating is harder than the second abrasive coating.

In some embodiments, the first abrasive coating comprises a first composite material comprising first abrasive particles such as cubic boron nitride particles embedded in a first matrix such as a nickel alloy matrix.

The second abrasive coating is more resistant to oxidation than the first abrasive coating.

In some embodiments, the second abrasive coating comprises a second composite material comprising second abrasive particles e.g. cubic boron nitride, silicon nitride, silicon carbide or aluminium oxide particles, embedded in a second matrix e.g. a nickel alloy matrix.

The silicon nitride, silicon carbide or aluminium oxide particles abrasive particles in the second abrasive coating typically have a greater oxidation resistance than the first abrasive particles in the first abrasive coating.

The abrasive particles in the second abrasive coating may be embedded into the second matrix to a greater extent than the first abrasive particles (e.g. cubic boron nitride particles) are embedded into the first matrix in the first composite abrasive coating. This greater extent of embedding helps increase the oxidation resistance of the second abrasive coating.

In some embodiments, the second abrasive coating comprises a radially outermost protective layer for increasing the oxidation resistance. The protective layer may comprise an alumina-, nitrogen- or chromium-based material. For example the second abrasive coating may be subjected to chromising, aluminising or nitriding.

The radially outermost protective layer may also be applied to the first abrasive coating.

In some embodiments, the first abrasive coating is bonded to the first portion by a bonding layer. In some embodiments, the second abrasive coating is bonded to the second portion by a bonding layer.

The abrasive coatings may be applied using a wet plating process, direct laser deposition (DLD), laser cladding or spraying.

In a second aspect, the present invention provides a rotary blade having a blade tip according to the first aspect of the present invention.

In a third aspect, the present invention provides a gas turbine engine having a turbine comprising a plurality of blades according to the second aspect.

### BRIEF DESCRIPTION OF THE DRAWINGS

Embodiments of the invention will now be described by way of example with reference to the accompanying drawings in which:

FIG. 1 shows a cross-section through a ducted fan gas turbine engine;

FIG. 2 shows a cross-section through a turbine of the gas turbine engine; and

FIG. 3a shows a cross-section of a blade tip according to a first embodiment of the present invention;

FIG. 3b shows a cross-section of the blade tip according to a first embodiment of the present invention after erosion of the first abrasive coating;

FIG. 3c shows a perspective view of a blade tip according to the first embodiment;

FIG. 4a shows a cross-section of a blade tip according to a second embodiment of the present invention; and

FIG. 4b shows a perspective view of a blade tip according to the second embodiment.

### DETAILED DESCRIPTION AND FURTHER OPTIONAL FEATURES OF THE INVENTION

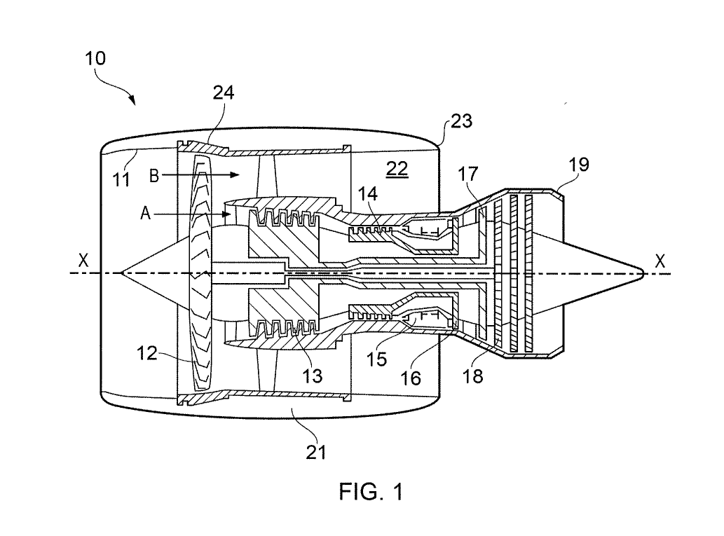

With reference to FIG. 1, a ducted fan gas turbine engine incorporating the invention is generally indicated at 10 and has a principal and rotational axis X-X. The engine comprises, in axial flow series, an air intake 11, a propulsive fan 12, an intermediate pressure compressor 13, a high-pressure compressor 14, combustion equipment 15, a high-pressure turbine 16, an intermediate pressure turbine 17, a low-pressure turbine 18 and a core engine exhaust nozzle 19. A nacelle 21 generally surrounds the engine 10 and defines the intake 11, a bypass duct 22 and a bypass exhaust nozzle 23.

During operation, air entering the intake 11 is accelerated by the fan 12 to produce two air flows: a first air flow A into the intermediate pressure compressor 13 and a second air flow B which passes through the bypass duct 22 to provide propulsive thrust. The intermediate pressure compressor 13 compresses the air flow A directed into it before delivering that air to the high pressure compressor 14 where further compression takes place.

The compressed air exhausted from the high-pressure compressor 14 is directed into the combustion equipment 15 where it is mixed with fuel and the mixture combusted. The resultant hot combustion products then expand through, and thereby drive the high, intermediate and low-pressure turbines 16, 17, 18 before being exhausted through the nozzle 19 to provide additional propulsive thrust. The high, intermediate and low-pressure turbines respectively drive the high and intermediate pressure compressors 14, 13 and the fan 12 by suitable interconnecting shafts.

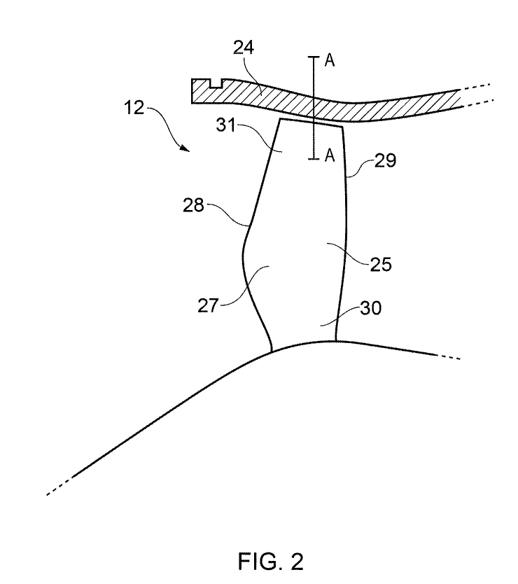

FIG. 2 shows an axial cross section through the turbine 17. The turbine blade has a blade body 25 with a suction face 26 (not shown), a pressure face 27, a leading edge 28, a trailing edge 29, a root portion 30 and tip portion 31.

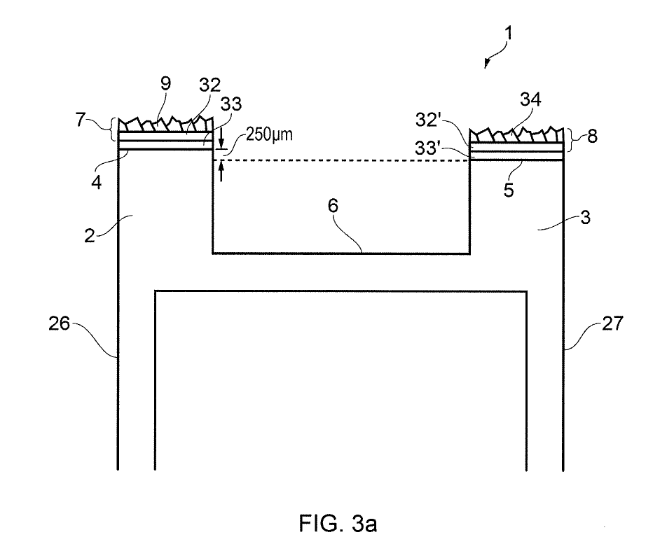

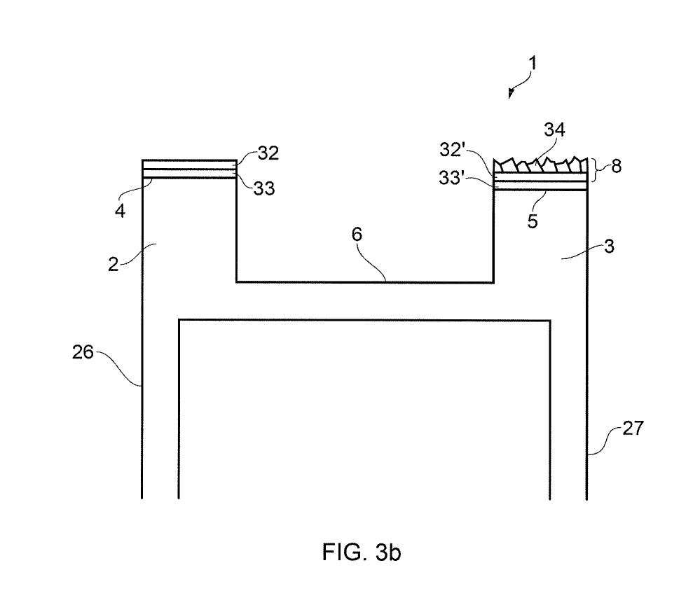

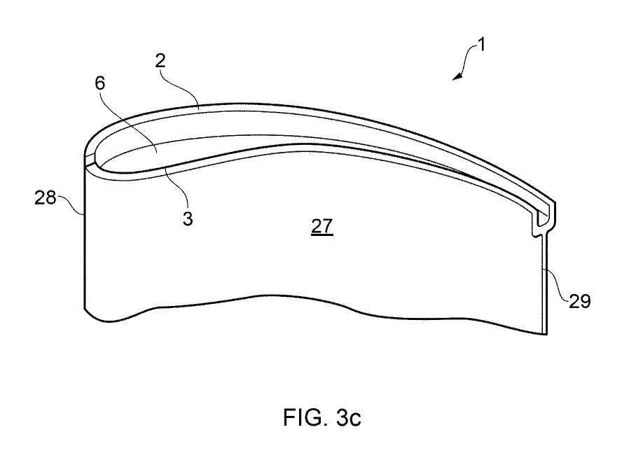

FIG. 3a shows a cross-sectional view of a first embodiment (squealer tip embodiment) of the tip portion 31 of the turbine blade along line A-A in FIG. 2. FIG. 3c shows a perspective view of the tip portion 31 of the turbine blade.

The tip portion 31 comprises a blade tip 1 which is integral with the aerofoil-shaped blade body 25 and comprises a first portion 2 and a radially-recessed second portion 3 i.e. the distance from the root portion 30 to the radially outer face 4 of the first portion 2 is greater (by 250 microns) than the distance from the root portion 30 to the radially outer face 5 of the second portion.

The first portion 2 comprises a radially-extending rail that extends along the radially outer edge of the suction face 26 from the leading edge 28 to the trailing edge 29. The second portion 3 comprises a radially-extending rail that extends along the radially outer edge of the pressure face 26 from the leading edge 28 to the trailing edge 29. The first and second radially extending rails extend from a tip floor 6 which is recessed from both of the radially extending rails and spaces them from one another.

The radially outer face 4 of the first portion 2 comprises a first abrasive coating 7 and the radially outer face 5 of the second portion 3 comprises a second abrasive coating 8. The second abrasive coating 8 has a greater resistance to oxidation than the first abrasive coating.

The first abrasive coating 7 is a composite material comprising cubic boron nitride particles 9 embedded in a nickel alloy matrix 32. The nickel alloy matrix 32 is bonded to the outer face 4 of the first portion 2 by a bonding layer 33.

The second abrasive coating 8 is a composite material comprising silicon carbide, silicon nitride or aluminium oxide particles 34 embedded in a nickel alloy matrix 32′. The nickel alloy matrix 32′ is bonded to the outer face 5 of the second portion 3 by a bonding layer 33′.

The cubic boron nitride particles 9 in the first abrasive coating 7 on the first portion 2 having a greater radial extension will abrade the liner on the turbine casing 24 during the early running of the engine to form a channel in which the turbine blades can run within reduced clearance thus maximising engine efficiency. During this early running of the engine, the second coating 8 on the second portion 3 will remain un-abraded because it is radially recessed and is protected by the first portion 2 (which is upstream). Furthermore, the second coating will remain un-oxidised owing to its greater resistance to oxidation.

Once the cubic boron nitride particles 9 in the first abrasive coating 7 on the first portion 2 have been eroded (see FIG. 3b), the silicon carbide, silicon nitride or aluminium oxide particles 34 in the second abrasive coating 8 on the second portion 3 will be available to abrade the turbine casing liner e.g. in extreme events such as heavy gusts or bird strike. The outer surface 4 of the first portion 2 remains protected by the nickel alloy matrix 32 and the bonding layer 33.

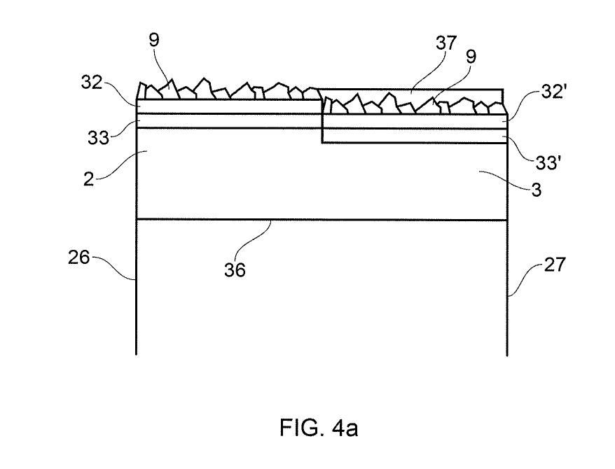

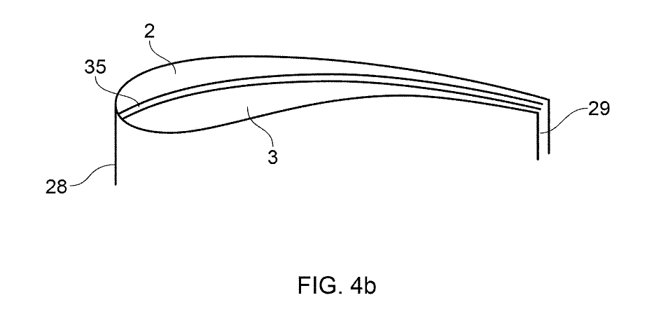

FIG. 4a shows a cross-sectional view of a second embodiment (solid tip embodiment) of the tip portion 31 of the turbine blade along line A-A in FIG. 2. FIG. 4b shows a perspective view of the tip portion 31 of the turbine blade.

In this second embodiment, the blade tip 1 is a cap having a mounting surface 36 which is mounted onto the radially outermost surface of the blade body 25. The first portion 2 and second portion 3 join at a step 35 extending along the camber line. The distance from the mounting surface 36 to the radially outer face 4 of the first portion 2 is greater (by 250 microns) than the distance from the mounting surface 36 to the radially outer face 5 of the second portion 3.

The first abrasive coating 7 and second abrasive coating are both a composite material comprising cubic boron nitride particles 9 embedded in a nickel alloy matrix 32. The nickel alloy matrix 32 is bonded to the outer faces 4, 5 of the first portion 2 and second portion 3 by respective bonding layers 33, 33′.

The second abrasive coating 8 comprises a protective layer 37 of alumina or chromium based material to increase the oxidation resistance of the second abrasive coating 8.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

1. A blade tip for a rotary blade, the blade tip comprising a first portion and a radially-recessed second portion, wherein a radially outermost surface of the first portion comprises a first abrasive coating and a radially outermost surface of the second portion comprises a second abrasive coating, the second abrasive coating having a greater resistance to oxidation than the first abrasive coating.

2. A blade tip according to claim 1 wherein the first portion is provided proximal a convex suction face.

3. A blade tip according to claim 1 wherein the first portion is a first radially extending rail and the second portion is a second radially extending rail, the radial extension of the first radially extending rail being greater than the radial extension of the second radially extending rail.

4. A blade tip according to claim 3 wherein the first radially extending rail extends adjacent a convex suction face and the second radially extending rail extends adjacent a concave pressure face.

5. A blade tip according to claim 4 wherein the first and second radially extending rails extend from and are mutually spaced by a radially recessed tip floor.

6. A blade tip according to any claim 1 wherein the first portion has a radial extension that is between 100 and 400 microns greater than that of the second portion.

7. A blade tip according to claim 1 wherein the first abrasive coating comprises a first composite material comprising first abrasive particles embedded in a first matrix.

8. A blade tip according to claim 7 wherein the first abrasive particles are cubic boron nitride particles and the first matrix is a nickel alloy matrix.

9. A blade tip according to claim 1 wherein the second abrasive coating comprises a second composite material comprising second abrasive particles embedded in a second matrix.

10. A blade tip according to claim 9 wherein the second abrasive particles are silicon carbide, silicon nitride or aluminium oxide particles and the second matrix is a nickel alloy matrix.

11. A blade tip according to claim 9 wherein the second abrasive particles are embedded into the second matrix to a greater extent than the first abrasive particles are embedded into the first matrix.

12. A blade tip according to claim 1 wherein the second abrasive coating comprises a radially outer protective layer.

13. A blade tip according to claim 12 wherein the protective layer comprises an alumina, nitrogen or chromium-based material.

14. A rotary blade having a blade tip according to claim 1

15. A gas turbine engine having a turbine comprising a plurality of blades according to claim 14.
